(19) United States
(12) Patent Application Publication
(10) Pub. No.: US 2007/0097883 A1
(43) Pub. Date: May 3, 2007

(54) Generation of a network topology hierarchy

(76) Inventors: Yigong Liu, Herndon, VA (US); Yevgeny Gurevich, Washington, DC (US); Pradeep K. Singh, Arlington, VA (US); Alain J. Cohen, Washington, DC (US); Vivek Narayanan, Rohnert Park, CA (US); Russell Mark Elsner, Bethesda, MD (US); Clinton David Hart, Frederick, MD (US)

Correspondence Address: ROBERT M. MCDERMOTT, ESQ., 1824 FEDERAL FARM ROAD, MONTROSS, VA, 22520, US

(21) Appl. No.: 11/506,651

(22) Filed: Aug. 18, 2006

Related U.S. Application Data
(60) Provisional application No. 60/709,764, filed on Aug. 19, 2005.

(51) Int. Cl. H04L 12/28

(52) U.S. Cl. 370/254

(57) ABSTRACT

A new network topology visualization is produced from an existing network topology using grouping algorithms that are selectively applied to selectable hierarchies of the existing network topological hierarchy. The new network topology is rendered for review. Interaction may be provided through a graphical user interface (GUI). The new network topology is provided as a previewing visualization. The previewing visualization is provided in a tree-view. The previewing visualization provides a visual differentiation between portions of the network topology that are changed by the grouping algorithm and portions that are not changed. The grouping algorithms may be provided as plug-in algorithms. A further new network topology may be rendered in response to receipt of a changed network topology.

This application claims the benefit of U.S. Provisional Patent Application No. 60/709,764, filed Aug. 19, 2005.

### BACKGROUND AND SUMMARY OF THE INVENTION

The present system relates to the field of presenting a network visualization and particularly to the generation of a network hierarchical view.

Computers are today used extensively by users to implement many applications. Users interact through a user interface (UI) provided by an application running on the computer. The visual environment is displayed by the computer on a display device and the user is provided with an input device to influence events or images depicted on the display. UI's present visual images which describe various visual metaphors of an operating system, an application, etc. implemented on the computer.

The user typically moves a user-controlled object, such as a cursor or pointer, across a computer screen and onto other displayed objects or screen regions, and then inputs a command to execute a given selection or operation. Other applications or visual environments also may provide user-controlled objects such as a cursor for selection and manipulation of depicted objects in either of a two-dimensional or three-dimensional space.

The user interaction with and manipulation of the computer environment is achieved using any of a variety of types of human-computer interface devices that are connected to the computer controlling the displayed environment. A common interface device for UI's is a mouse or trackball. A mouse is moved by a user in a planar workspace to move an object such as a cursor on the two-dimensional display screen in a direct mapping between the position of the user manipulation and the position of the cursor. This is typically known as position control, where the motion of the object directly correlates to motion of the user manipulation.

An example of such a UI is a UI for depicting/manipulating network connections to assist a user, such as a network administrator, to visualize and maintain vast arrays of networked devices. A typical visualization of a computer network is a two-dimensional graph where the vertices correspond to devices and the edges correspond to physical links or connections. The edges may also or alternatively correspond to non-physical associations or dependencies. By the visualization of network devices and links within a suitable UI, an operator may readily get an overview of network topology and operations including communication load, service availability, network collisions, and/or other network related information.

Management of a communications network is a complex and time-consuming task, particularly as the size and capabilities of such networks continues to grow. A properly designed network topology hierarchy conveys to users important information such as organizational structures and geographical distributions, enabling users to comprehend large scale complicated networks easily.

Prior systems of generating network topology hierarchy visualizations involve a manual process of “drag-dropping” specific node(s) into a subnet to create the visualization. Other systems enable a limited automatic process of grouping some nodes into one or a few subnets at the same level of network hierarchy based on some criteria such as physical proximity. There are no existing tools which can flexibly create or change the multi-level network topology hierarchy based on algorithms, interaction with a graphical user interface (GUI) and network properties as is becoming increasingly necessary for handling large scale complicated networks.

It is an object of the present system to overcome disadvantages and/or make improvements in the prior art.

The present system includes a system, method and device for generating a network topology visualization from an existing network topology. Grouping algorithms are selectively applied to selectable hierarchies of the existing network topological to produce a new network topology. The new network topology is rendered for review. Interaction may be provided through a graphical user interface (GUI). The new network topology is provided as a previewing visualization. The previewing visualization may be provided in a tree-view, such as a flat tree-view. The previewing visualization may provide a visual differentiation between portions of the network topology that are changed by the grouping algorithm and portions that are not changed.

Grouping algorithms may be applied, removed and/or altered as may be the selectable levels of hierarchy during a reviewing process. Grouping algorithms may be retrieved prior to being applied to the network topology. Parameters of an algorithm may be altered. Following the review process, the new network topology may be laid out to provide a hierarchical visualization of the new network topology. The visualization may be laid out dependent on a number of nodes depicted in the visualization and an area available for providing the visualization.

In operation, different grouping algorithms may be selectively applied to different portions of the retrieved network topology. Within the GUI, a first visual area may be provided wherein levels for forming the new network topology are specified. The first visual area may provide an identification of the grouping algorithm utilized for modifying each of the levels. A second visual area may be provided wherein algorithms applied to form the levels of the new network topology are specified and/or adjusted.

### BRIEF DESCRIPTION OF THE DRAWINGS

The invention is explained in further detail, and by way of example, with reference to the accompanying drawings wherein:

FIG. 1 shows an operation in accordance with an embodiment of the present system;

FIG. 2 shows a portion of a GUI that illustrates levels of a network hierarchy including an identification of grouping algorithms that may be utilized for manipulation of the visualization of the network topology in accordance with an embodiment of the present system;

FIG. 3 shows a portion of a GUI that may be provided as a secondary dialogue box as a result of a selection of one of the grouping levels provided;

FIG. 4 provides a process flow diagram illustrating a processing flow that may be utilized in accordance with an embodiment of the present system;

FIG. 5 provides a view of a complex network topology representing an entire network or a portion thereof and a subnet selection process in accordance with an embodiment of the present system;

FIG. 6 provides a view of the network shown in FIG. 5 after application of a set of grouping algorithms in accordance with an embodiment of the present system; and

FIG. 7 shows a device in accordance with an embodiment of the present system.

### DETAILED DESCRIPTION

The following are descriptions of illustrative embodiments that when taken in conjunction with the following drawings will demonstrate the above noted features and advantages, as well as further ones. In the following description, for purposes of explanation rather than limitation, specific details are set forth such as architecture, interfaces, techniques, etc., for illustration. However, it will be apparent to those of ordinary skill in the art that other embodiments that depart from these details would still be understood to be within the scope of the appended claims. Moreover, for the purpose of clarity, detailed descriptions of well-known devices, circuits, and methods are omitted so as not to obscure the description of the present system.

It should be expressly understood that the drawings are included for illustrative purposes and do not represent the scope of the present system. In the accompanying drawings, like reference numbers in different drawings designate similar elements. For purposes of simplifying a description of the present system, as utilized herein regarding the present system, the term network topology is intended to include features of the network hierarchy unless explicitly or implicitly stated otherwise.

The system and method described herein address problems in prior art systems. In accordance with the present system, an automated process is provided that enables an algorithmic generation of a potentially multi-level network topology including network hierarchy. Further, the present system enables the application of different algorithms at different levels of hierarchy if desired. Algorithms for grouping nodes into subnets based on network properties may be readily integrated. Advantageously, the present system may provide a GUI workspace where users may specify algorithms, parameters of algorithms, subnets, preview a resulting new hierarchy, and other operations of the like. Modifications may be readily removed to enable going back to a previous topology. In this way, a user may readily experiment with various algorithms and parameter settings till a satisfactory network topological visualization is achieved.

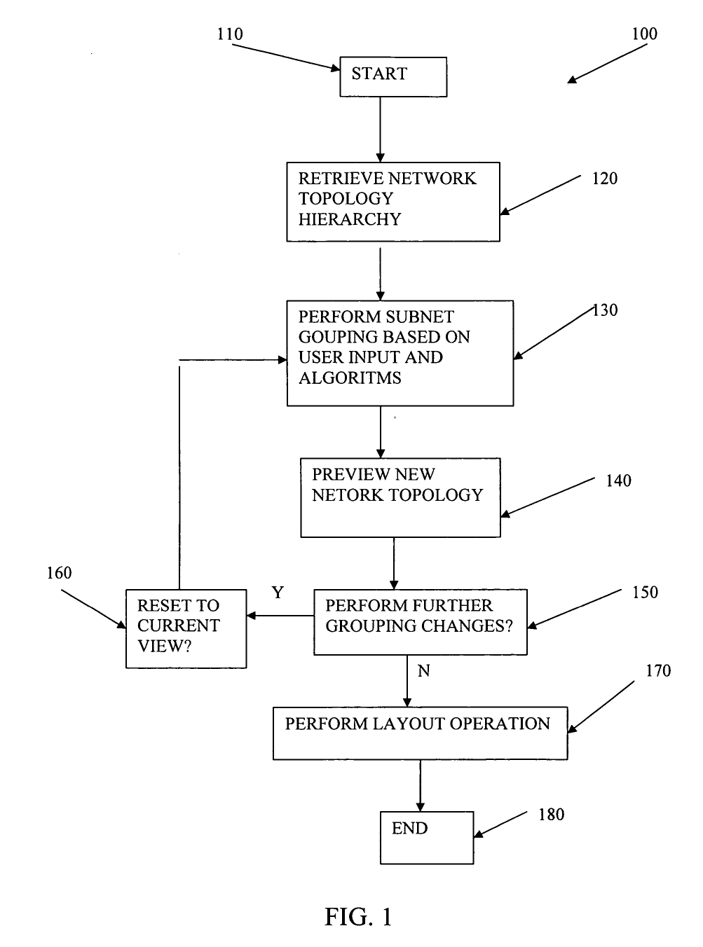

Further operation of the present system will be provided including a discussion of an illustrative flow diagram provided in FIG. 1 which shows an operation in accordance with an embodiment of the present system. In one embodiment, the present system may function as a sub-system of a network layout process that gathers data representing a network topology. This topology describes the interconnections of the network devices including hierarchical interconnection information. For example, this information may include the network topology hierarchy of an entire network or some portion thereof. During act 120, the current existing network topology may be retrieved, for example from a hosting system. An internal representation may be created at this time for further operations as described herein below. Advantageously, the internal representation enables experimentation with changes to the existing network topology without affecting the existing network topology.

Subnet grouping operations may be carried out during act 130 on these internal representations. The subnet groupings may be performed based on user input. For example, the user input may directly select particular groupings. In another embodiment, an algorithm producing groupings may be selected and/or applied. Further, parameters of algorithms may be altered and/or applied. During act 140, a preview of a resulting network topology is provided including a resulting hierarchy.

Subnet grouping may be performed as an iterative process during act 150 in which interactive users may provision various algorithms and parameter settings to change existing network topology, create new hierarchy and preview the resultant new topology. In a case wherein the resulting topology does not produce a satisfying result, the new topological view may be reset back to the current topological view during act 160. In this way, the user may experiment with algorithms and parameter settings till a satisfactory topology, including topological hierarchy, is achieved. Once a satisfactory network topology is achieved, post-processing is performed during act 170 to determine a lay out of the nodes and produce the visualization of the resulting topology.

In accordance with the present system, the changed topology may have multiple levels of hierarchy and at each level, different algorithms, parameters, etc. may be applied. For example, algorithms may be applied as a chain of filters wherein an initial set of candidate nodes is operated on by a first algorithm. Thereafter, a set of remaining nodes that have not yet been operated on may have a second algorithm applied, and so on. In another embodiment, the algorithms may be applied in parallel or in different orders of application in that particular nodes may not be operated on based on characteristics of the algorithm or based on a selected application of the algorithm directly, irrespective of an order of application of the algorithm. For example, a particular algorithm may direct a combination of all routers within a given geographic location be represented as a single node on the visualization of the topology. This algorithm would not affect a topology of client machines and as such, an algorithm related to the topology of client machines may be applied to all or some subset of the client machines without an affect on the topology of the servers. Similarly, an algorithm may be applied to different levels or portions of the topology without an affect on some other level or portion.

As should be clear from the above description, the changed network topology may have multiple levels of hierarchy and the algorithms may be flexibly applied. For example, algorithms defined at a lower level may be recursively applied to groups of nodes created by applying algorithms at an upper level. Other combinations of applying algorithms may be readily applied in accordance with the present system.

A GUI may provide an environment for making changes to the existing topology and for providing a graphical representation of a current existing network topology including network hierarchy and a new network topology created by application of the user input, algorithms, etc. For example, changes in network topology brought about by application of one or more algorithms may be differentiated from the current topology using visual indications such as provided be a change in a type of indication (e.g., iconic representation), a change in color of the representation, an addition of a further indication (e.g., underlining), etc. Other ways may be suitably utilized for providing a visual indication distinguishing between current network topology including topological hierarchy and new network topology as would be readily appreciated by a person of ordinary skill in the art.

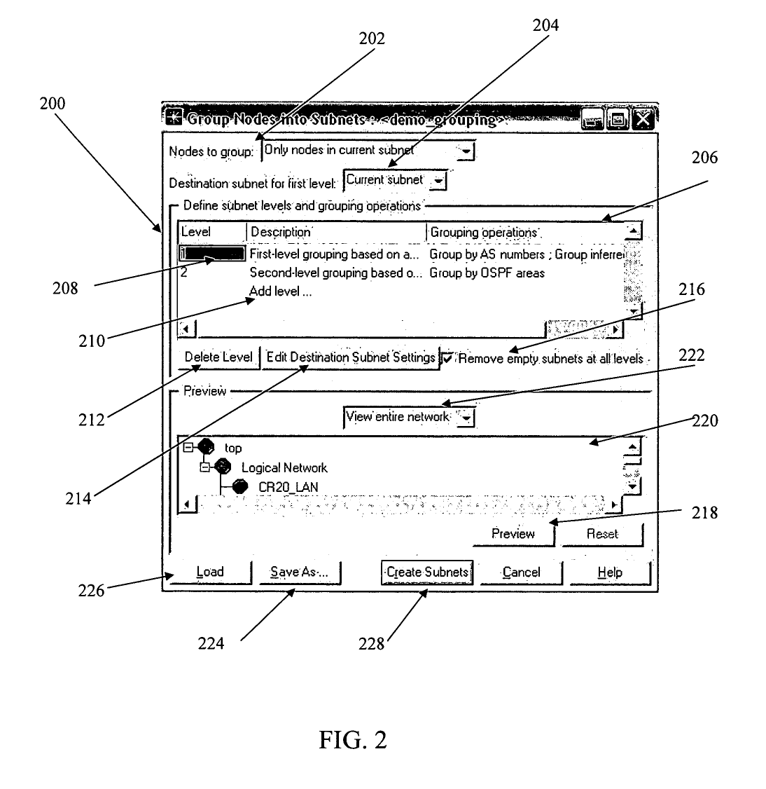

To facilitate manipulation of the network topology, the GUI may provide different views that are directed to different portions of the manipulation process. For example, the GUI may present grouping algorithms and parameter settings for the algorithms in separate portions of the GUI. FIG. 2 shows a portion of a GUI 200 that illustrates levels of a network hierarchy including an identification of grouping algorithms that may be utilized for manipulation of the visualization of the network topology in accordance with an embodiment of the present system. The GUI 200 may be provided as a top-level dialogue box as understood by a person of ordinary skill in the art.

The GUI 200 is shown depicted in a typical UI including a windowing environment and as such, may include menu items that are typical of those provided in a windowing environment, such as may be represented within a Windows™ Operating System graphical UI as provided by Microsoft Corporation. The objects and sections of the GUI may be navigated utilizing a user input device, such as a mouse, trackball and/or other suitable user input. Further, the user input may be utilized for making selections within the GUI 200 such as by selection of a “radio button” type selection paradigm as understood by a person of ordinary skill in the art. The GUI 200 may be organized to facilitate manipulation of multiple levels of hierarchy for providing an altered network topology.

The GUI 200 is illustratively shown having two separate display regions, a first region 206 shows algorithms that are being applied to different hierarchical levels of the current network topology and/or portions of the current network topology. As such, an area 202 may designate which portion of the current network topology is being manipulated by selected levels of algorithms. In the illustrative example, “only nodes in current subnet” are grouped by the levels of algorithms provided/applied as designated in the area 206. A further area 204 may be utilized to designate a topological location for a result of the applied algorithms. In this way, the algorithms may be applied to break network topologies apart or to reorder a given portion of the topology by indicating a location other than the current subnet.

Further levels of applying algorithms may be applied by selecting an “Add level . . . ” indication 210. In this way, a user may add further levels of algorithms to be applied to the current network topology, as modified by previous levels of algorithms (e.g., illustratively shown, level 1 and level 2). The indication 210 is also provided as a way of initiating an initial modification of the network topology by adding a first level when no prior levels previously exist for a designated portion (e.g., current subnet) of the network topology. Levels of applied algorithms previously added may be deleted by selecting a “Delete Level” area 212. Other selection areas may be provided. For example, an area 214 may be provided to enable editing of the destination subnet for the result of the current levels of algorithms. A further area 216 may be provided to simplify a resulting topology by removing from a topological visualization, empty subnets that result from application of the levels of algorithms.

As should be clear from the above description, the algorithms as applicable in accordance with the present system may be flexibly applied. Given algorithms may be selectively applied to one or more levels, subnets, etc. of the network topology. In accordance with the present system, given algorithms may be altered (e.g., from one level to another level) by a change in parameters, different algorithms may be applied and/or combinations of algorithms may be selectively applied. For example, algorithms defined at a lower level may be recursively applied to groups of nodes created by applying algorithms at an upper level. Clearly other combinations and modifications to the application of algorithms would occur to a person of ordinary skill in the art and may be applied in accordance with the present system.

An area 218 may be provided to enable presentation of a preview 220 of the resulting topology. Selection of the area 218 may result in a presentation of an area that provides the preview topology. In this way, the result of one or more applied levels of algorithms may be previewed prior to applying the one or more levels of algorithms to the current topology. Illustratively, the preview topology may be provided in a tree-view to facilitate a review of the preview although other display formats may be suitably applied. To facilitate an identification of a potential change in the network topology brought about by an application of algorithms, nodes presented in the preview 220 may be visually differentiated to indicate whether a given node is altered or unaffected by the applied levels of algorithms. For example, a particular color may be utilized to indicate a node that will remain in its original position in the network topology as a result of the application of the one or more levels of algorithms while a different color may be utilized to indicate a node that is altered in the preview network topology. An area 222 may be provided for limiting the preview 220 to a selected portion of the entire network. The settings provided by the selections and alterations indicated in the area 206 may be saved by selecting an area 224. Previous saved setting may be loaded by selection of an area 226. New subnets for application of the one or more levels of algorithms may be created by selection of an area 228. Each of the new subnets may have the same or other levels of algorithms applied in accordance with the present system.

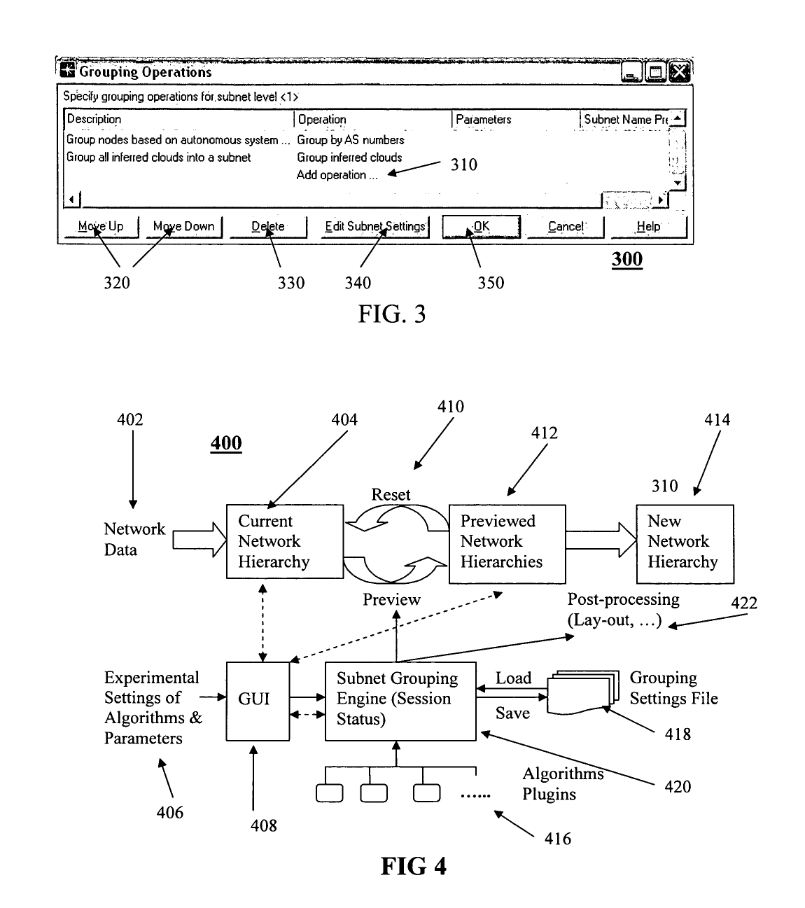

FIG. 3 shows a portion of a GUI 300 that may be provided as a secondary dialogue box as a result of a selection of one of the grouping levels provided in the GUI 200. For example, a user may select one of the grouping levels as shown by indication 208. Thereafter, a “right-click”, “double-click”, etc., on the selected grouping level may be provided in the GUI 200 to enable production of the GUI 300 related to the selected grouping level. The GUI 300 enables a user to designate algorithms that are applied at each level of the network topology. For example, selection of an area 310 may be utilized to add application of an algorithm or selection of an area 330 may be utilized to delete application of an algorithm. The GUI 300 also provides a way for the user to adjust parameters that are associated with designated algorithms by selection of an area 340. An order of application of designated algorithms may be adjusted through selection of areas 320. Once it is desired to save a given algorithm configuration for the designated level, an area 350 may be selected. An add operation 310 may result in an ability to create and/or modify an algorithm directly and/or may result in a production of a browsing window to enable selection of a pre-existing algorithm. Pre-existing algorithms may operate as plug-ins to the present system to enable a sharing of an algorithm that is created by a third party. In one embodiment in accordance with the present system, the GUI 200 and the GUI 300 may be provided simultaneously such that changes made in the GUI 300 may be previewed directly and dynamically in the GUI 200.

The present system facilitates creation of a new network topology by applying grouping algorithms that may be selectively applied across the network or at different levels of hierarchy as desired. Due to operation in accordance with the present system, users may readily experiment with different algorithms and parameter settings till a satisfactory network topology is achieved.

FIG. 4 provides a process flow diagram 400 illustrating a processing flow that may be utilized in accordance with an embodiment of the present system. In operation, network data 402 is retrieved representing a current network topology 404. The network data 402 may be saved locally to facilitate operation in accordance with the present system. A user interacts with an interface, such as a GUI 408, utilizing experimental algorithms and parameters 406 and/or algorithm plug-ins 416 to ultimately produce a new network topology 414 including topological hierarchy that is provided by a subnet grouping engine 420. In accordance with an embodiment of the present system, grouping algorithms 416 may be organized in a flexible plug-in architecture. New and customized algorithms may be developed by third-party developers and easily integrated into the system by merely adding to and/or editing exiting grouping algorithms. In this way, one or more grouping algorithms that have been applied in another network that produced a desirable network grouping, may be readily applied to a further network requiring little or no modifications. In an embodiment wherein groupings are provided sequentially (e.g., a first algorithm operates on a portion of the network and a subsequent algorithm operates on a left-over portion of the network), further, particular plug-in algorithms may be replaced or removed without adversely altering groupings provided by other algorithms. In another embodiment, a given plug-in algorithm may be complimentary to a result of another plug-in algorithm in that a change in the given plug-in algorithm, will affect a result produced by another plug-in algorithm.

The new network topology 414 may be previewed 412 during a preview/reset phase 410. Algorithm combinations may be saved/loaded to/from a grouping settings file 418 and/or may be saved as algorithm plug-ins 416 to be utilized for future application and/or for exportation to be applied to a further network topology. One a desired new network topology is achieved, the subnet grouping engine 420 may process the selected algorithms and parameters during post-processing 422 to produce the new network topology 414. In one embodiment in accordance with the present system, the plug-in algorithms 416 and/or grouping setting file 418 may be applied automatically to any changes in the network model. For example, a live model of the network may be represented that is constantly or periodically updated as changes to the actual network occur. In such a case, for example, as new nodes appear, the present system may automatically group the new nodes according to previously selected grouping algorithms 416 and/or grouping settings file 418. In either event, the post-processing 422 performs the groupings based on the selected combination (e.g., algorithm plug-ins 416 and/or grouping settings file 418) and then lays out the new network hierarchy.

In operation, the subnet grouping engine 420 may locate the nodes of the new topology utilizing a coordinate space as provided by the original network topology. The layout operation moves nodes away from each other such that the nodes become separated by some suitable minimum distance to enable depiction of the nodes and any other information that may be desirable, such as textual indications (e.g., labels) of the depicted nodes. The subnet grouping engine 420 may lay out the new network topology providing a relative position of the objects that provides useful visual cues. For this reason, the subnet grouping engine 420 may start the layout operation by placing all of the nodes depicted in a similar relative position as provided in the “original” network topology provided in the network data 402. Nodes may be spaced apart to occupy a defined area while providing sufficient area around the nodes to accommodate labels to facilitate identification of the nodes. Further, the nodes should be depicted connected together indicating the appropriate network topology and hierarchy.

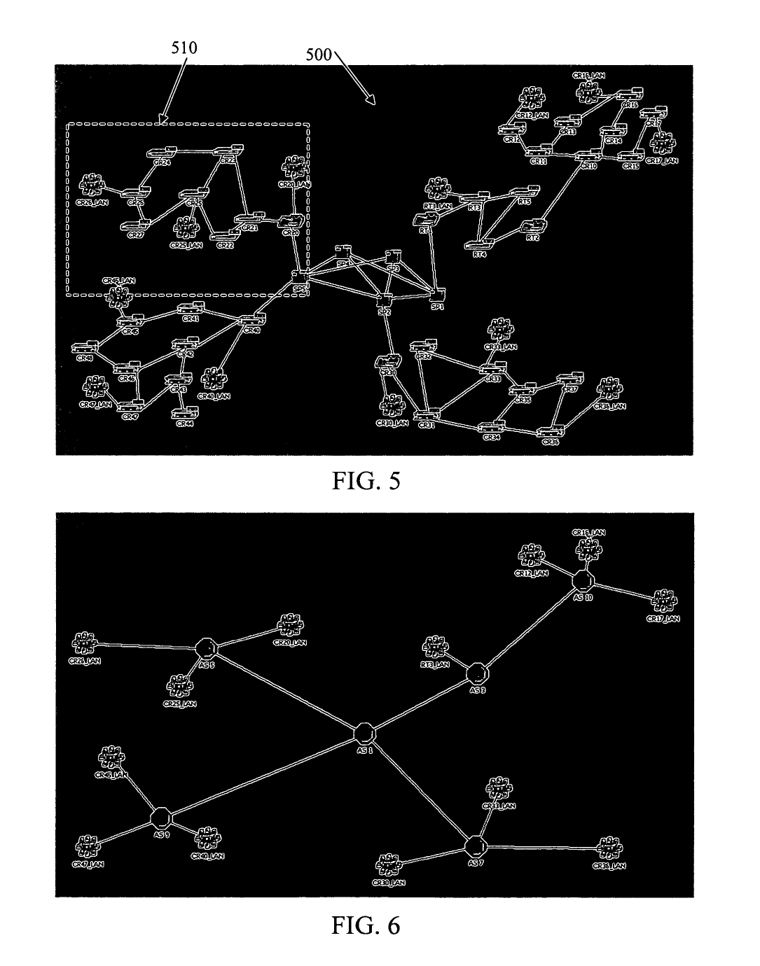

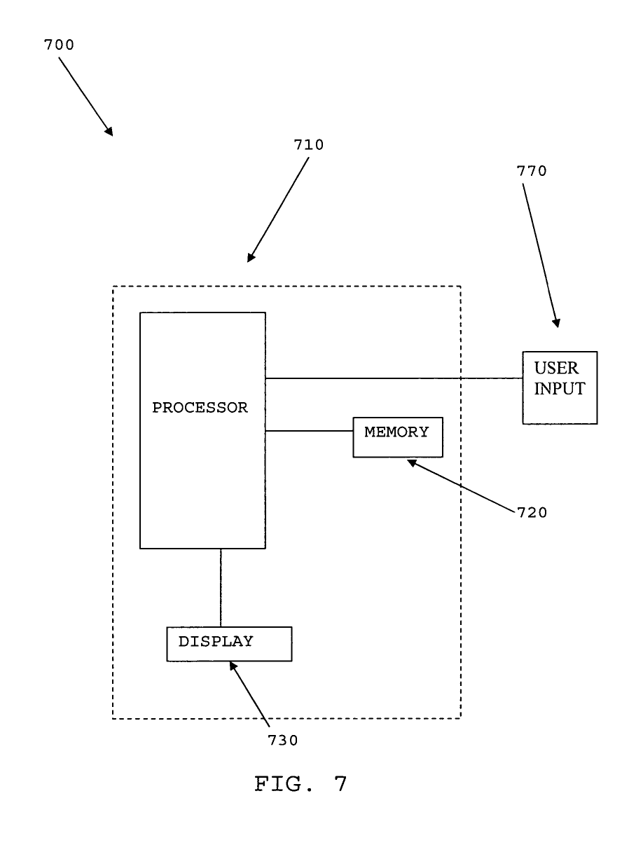

FIG. 5 provides a view 500 of a complex network topology representing an entire network or a portion thereof. FIG. 6 provides a view 600 of the same network after application of a set of grouping algorithms such as those shown in FIGS. 2 and 3 and subsequent to the layout process of the subnet grouping engine 420. The views provided in FIGS. 5 and 6 provide another means of selecting subnets for operation in accordance with an embodiment of the present system. For example, a new subnet may be created by dragging a bounding box 510 around an area of the network topology to create a subnet. The new subnet defined in this way may initiate a pop-up of the GUI 200 and thereby, enable further groupings within this newly defined subnet. Other systems for enabling formations of subnets as well as different layouts and content for one or more of the GUIs 200 and 300 would readily occur to a person of ordinary skill in the art and are intended to be encompassed by the present system.

FIG. 7 shows a device 700 in accordance with an embodiment of the present system. The device has a processor 710 operationally coupled to a memory 720, a display 730 and a user input device 770. The memory 720 may be any type of device for storing application data as well as other data, such as network topology data, coordinate data for network objects, label data for objects, interconnectivity of objects, etc. The application data and other data are received by the processor 710 for configuring the processor 710 to perform operation acts in accordance with the present system. The operation acts include controlling at least one of the display 730 to display content such as the GUIs 200, 300. The user input 770 may include a keyboard, mouse, trackball or other devices, including touch sensitive displays, which may be stand alone or be a part of a system, such as part of a personal computer, personal digital assistant, or other display device for communicating with the processor 710 via any type of link, such as a wired or wireless link. The user input device 770 is operable for interacting with the processor 710 including interaction within a paradigm of a GUI and/or selection of levels, algorithms, parameters, etc. and/or other elements of the present system. Clearly the processor 710, memory 720, display 730 and/or user input device 770 may all or partly be a portion of a computer system or other device.

The methods of the present system are particularly suited to be carried out by a computer software program, such program containing modules corresponding to one or more of the individual steps or acts described and/or envisioned by the present system. Such program may of course be embodied in a computer-readable medium, such as an integrated chip, a peripheral device or memory, such as the memory 720 or other memory coupled to the processor 710.

The computer-readable medium and/or memory 720 may be any recordable medium (e.g., RAM, ROM, removable memory, CD-ROM, hard drives, DVD, floppy disks or memory cards) or may be a transmission medium (e.g., a network comprising fiber-optics, the world-wide web, cables, or a wireless channel using time-division multiple access, code-division multiple access, or other radio-frequency channel). Any medium known or developed that can store and/or transmit information suitable for use with a computer system may be used as the computer-readable medium and/or memory 720.

Additional memories may also be used. The computer-readable medium, the memory 720, and/or any other memories may be long-term, short-term, or a combination of long-term and short-term memories. These memories configure processor 710 to implement the methods, operational acts, and functions disclosed herein. The memories may be distributed or local and the processor 710, where additional processors may be provided, may also be distributed or may be singular. The memories may be implemented as electrical, magnetic or optical memory, or any combination of these or other types of storage devices. Moreover, the term “memory” should be construed broadly enough to encompass any information able to be read from or written to an address in the addressable space accessed by a processor. With this definition, information on a network is still within memory 720, for instance, because the processor 710 may retrieve the information from the network for operation in accordance with the present system.

The processor 710 is capable of providing control signals and/or performing operations in response to input signals from the user input device 770 and executing instructions stored in the memory 720. The processor 710 may be an application-specific or general-use integrated circuit(s). Further, the processor 710 may be a dedicated processor for performing in accordance with the present system or may be a general-purpose processor wherein only one of many functions operates for performing in accordance with the present system. The processor 710 may operate utilizing a program portion, multiple program segments, or may be a hardware device utilizing a dedicated or multi-purpose integrated circuit.

Of course, it is to be appreciated that any one of the above embodiments or processes may be combined with one or more other embodiments or processes or be separated in accordance with the present system. As should be clear, the present system enables a user to develop a well designed network topology hierarchy that may convey to users important information including organizational structures, dependencies including geographical distributions, and network operations including communication load, service availability, network collisions, and/or other network related information. In this way, the present system provides a means to modify a depiction of a complex network topology to enable users to comprehend large scale complicated networks easily in a readily modifiable form.

Finally, the above-discussion is intended to be merely illustrative of the present system and should not be construed as limiting the appended claims to any particular embodiment or group of embodiments. Thus, while the present system has been described with reference to exemplary embodiments, it should also be appreciated that numerous modifications and alternative embodiments may be devised by those having ordinary skill in the art without departing from the broader and intended spirit and scope of the present system as set forth in the claims that follow. In addition, the section headings included herein are intended to facilitate a review but are not intended to limit the scope of the present system. Accordingly, the specification and drawings are to be regarded in an illustrative manner and are not intended to limit the scope of the appended claims.

In interpreting the appended claims, it should be understood that:
a) the word “comprising” does not exclude the presence of other elements or acts than those listed in a given claim;
b) the word “a” or “an” preceding an element does not exclude the presence of a plurality of such elements;
c) any reference signs in the claims do not limit their scope;
d) several “means” may be represented by the same item or hardware or software implemented structure or function;
e) any of the disclosed elements may be comprised of hardware portions (e.g., including discrete and integrated electronic circuitry), software portions (e.g., computer programming), and any combination thereof;
f) hardware portions may be comprised of one or both of analog and digital portions;
g) any of the disclosed devices or portions thereof may be combined together or separated into further portions unless specifically stated otherwise;
h) no specific sequence of acts or steps is intended to be required unless specifically indicated; and
i) the term “plurality of” an element includes two or more of the claimed element, and does not imply any particular range of number of elements; that is, a plurality of elements can be as few as two elements, and can include an immeasurable number of elements.

What is claimed is:

1. A method of generating a network topology visualization comprising:
retrieving a network topology;
applying a grouping algorithm to selectable hierarchies of a network topological hierarchy to produce a new network topology;
providing a visualization of the new network topology.

2. The method of claim 1, including providing a graphical user interface (GUI), wherein applying the grouping algorithm is performed within the GUI.

3. The method of claim 1, wherein providing the visualization includes providing a previewing visualization.

4. The method of claim 3, wherein the previewing visualization is provided in a tree-view.

5. The method of claim 3, wherein the previewing visualization provides a visual differentiation between portions of the network topology that are changed by the grouping algorithm and portions that are not changed.

6. The method of claim 1, including retrieving the grouping algorithm prior to applying the grouping algorithm.

7. The method of claim 1, wherein the grouping algorithm includes a plurality of grouping algorithms and applying the grouping algorithm includes altering one of the plurality of grouping algorithms.

8. The method of claim 1, wherein the grouping algorithm includes a plurality of grouping algorithms and the plurality of grouping algorithms are in a form of a plug-in architecture that provides a grouping result provided from one of the plurality of grouping algorithms that is independent of a result from others of the plurality of grouping algorithms.

9. The method of claim 1, wherein the grouping algorithm is a plurality of grouping algorithms and the plurality of grouping algorithms are in a form of a plug-in architecture that provides a grouping result provided from one of the plurality of grouping algorithms that is complimentary to a result from others of the plurality of grouping algorithms.

10. The method of claim 1, wherein applying the grouping algorithm includes adjusting a parameter of an algorithm of the grouping algorithm.

11. The method of claim 1, wherein providing the visualization includes processing the new network topology to layout the visualization dependent on a number of nodes depicted in the visualization and an area available for providing the visualization.

12. The method of claim 1, including:
reviewing the provided visualization; and
altering the applying based on an outcome of the reviewing.

13. The method of claim 1, wherein applying the grouping algorithm includes:
applying a first grouping algorithm to a first portion of the retrieved network topology; and
applying a second grouping algorithm to a second portion of the retrieved network topology that is a different portion than the first portion.

14. The method of claim 1, wherein providing the visualization includes providing a first visual area wherein levels for forming the new network topology are specified.

15. The method of claim 14, wherein providing the first visual area includes providing an identification of the grouping algorithm utilized for modifying each of the levels.

16. The method of claim 14, wherein providing the visualization includes providing a second visual area wherein algorithms applied to form the levels of the new network topology are specified.

17. The method of claim 1, wherein algorithms defined at a lower level of the network topology may be recursively applied to groups of nodes created by applying algorithms at an upper level.

18. The method of claim 1, including:
receiving a changed network topology;
applying the grouping algorithm and providing the visualization are based on the changed network topology.

19. The method of claim 18, wherein applying the grouping algorithm and providing the visualization are performed in response to receipt of the changed network topology.

20. A data structure stored on a computer readable memory medium representing configurable groupings of a hierarchical network topology, the data structure comprising:
a first portion arranged to store data related to selectable levels of hierarchy of a new network topology based on the hierarchical network topology; and
a second portion arranged to store grouping algorithms corresponding to the selectable levels of hierarchy.

21. The data structure of claim 20, including a third portion arranged to store a representation of the hierarchical network topology utilized for producing the first and second portions.

22. The data structure of claim 21, wherein the third portion is arranged to enable a relocation of nodes of the representation of the hierarchical network topology.

23. The data structure of claim 21, wherein the third portion is arranged to enable a relocation of sub-branches of the representation of the hierarchical network topology.

24. The data structure of claim 20, wherein the second portion is arranged to store parameters related to the grouping algorithms.

25. The data structure of claim 20, including a third portion arranged to store an indication of nodes that are altered between the hierarchical network topology and the new network topology.

26. The data structure of claim 20, including a third portion arranged to store grouping settings data identifying an arrangement of the data stored in the first and second portions.

27. The data structure of claim 20, including a third portion arranged to store data related to a preview visualization of the new network topology.

28. The data structure of claim 20, wherein the second portion is arranged to store the grouping algorithms as independent plug-ins.

29. The data structure of claim 20, wherein the second portion is arranged to store the grouping algorithms as complementary plug-ins.

30. An application embodied on a computer readable medium configured to produce a user interface for an iterative analysis and design process, the application comprising:
a first portion configured to identify levels of hierarchy to be applied to a network topology; and
a second portion configured to receive grouping algorithms corresponding to the identified levels of hierarchy, wherein the first portion and second portion together are configured to produce a new network topology.

31. The application of claim 30, including a third portion configured to produce a preview of the new network topology.

32. The application of claim 31, wherein the third portion is configured to produce the preview as a tree-view identifying levels of hierarchy.

33. The application of claim 31, wherein the third portion is configured to produce the preview to provide an indication of nodes that are altered between the hierarchical network topology and the new network topology.

34. The application of claim 30, wherein the second portion is configured to receive parameters related to the grouping algorithms.

35. The application of claim 30, wherein the second portion is configured to receive grouping algorithms from a storage device.

36. The application of claim 35, wherein the grouping algorithms are in a form of a plug-in architecture that provides a grouping result provided from one of the grouping algorithms that is independent of a result from others of the grouping algorithms.

37. The application of claim 35, wherein the grouping algorithms are in a form of a plug-in architecture that provides a grouping result provided from one of the grouping algorithms that is complimentary to a result from others of the grouping algorithms.

38. The application of claim 30, wherein the second portion is configured to store grouping algorithms and applied levels of hierarchy to a storage device.

39. The application of claim 30, including a third portion configured to restore a previous network topology by removing application of at least one of the identified levels.

40. The application of claim 30, including a third portion configured to restore a previous network topology by removing application of at least one of the grouping algorithms.

41. The application of claim 30, including a third portion configured to receive a changed network topology, wherein the first and second portions are configured to produce a further new network topology based on the changed network topology.

42. The application of claim 41, wherein the first and second portions are configured to produce the further new network topology in response to receipt of the changed network topology.
